(19) United States
(12) Patent Application Publication
(10) Pub. No.: US 2012/0022955 A1
(43) Pub. Date: Jan. 26, 2012

(54) SYSTEM AND METHOD FOR PROCESSING DONATIONS OF STORED VALUE ACCOUNTS

(76) Inventors: Lawrence Bracco, Pacific Palisades, CA (US); Daniel Najor, Solano Beach, CA (US)

(21) Appl. No.: 13/191,413

(22) Filed: Jul. 26, 2011

Related U.S. Application Data
(60) Provisional application No. 61/367,718, filed on Jul. 26, 2010.

(51) Int. Cl. G06Q 40/00

(52) U.S. Cl. 705/16; 705/41

(57) ABSTRACT

A system for processing donations of stored value accounts includes a user interface configured to receive a first account identifier, a first issuer identifier, and a first donee identifier; and a donation processor configured to process the first account identifier, the first issuer identifier, and the first donee identifier and to transmit the first account identifier and the first donee identifier to a first issuer associated with the first issuer identifier.

### CROSS-REFERENCE TO RELATED APPLICATION

This application claims priority to and the benefit of U.S. Provisional Patent Application No. 61/367,718 filed in the United States Patent and Trademark Office on Jul. 26, 2010, the entire disclosure of which is incorporated by reference herein.

### BACKGROUND

In the field of stored value accounts such as gift cards issued by retailers, consumers often spend less than the full balances of their gift cards and the remaining balance may, after time, be too small (e.g., less than $1) to make significant purchases. These small remaining unused funds may be practically worthless to the consumers.

The total aggregate volume of gift cards purchased in 2008 was approximately $91 billion. The total aggregate volume of gift cards that were predicted to be purchased for all of 2009 was approximately $87 billion. The highest percentage ever recorded for unused gift cards (called “spillage”, “spoilage”, or “breakage”) was approximately 10% of all gift cards purchased in 2007. Approximately 40% of gift cardholders don't use the full value of the cards. The average balance left on gift cards is $2.30. The percentage of unused gift cards for 2009 is predicted to be 6% and represents approximately $5 billion of unused gift cards. It is estimated that Wal-Mart, for example, could have close to $1 billion of unused gift cards out in circulation.

The billions of dollars in stored value represent an untapped resource and a significant opportunity for facilitating donations of the unused value.

### SUMMARY

Embodiments of the present invention are directed to a system and method for processing donations of stored value accounts. In one embodiment, the donation processing system (or donation processor) receives stored value account information and recipient non-profit organization identifiers from consumers (or donors), aggregates the account information by stored value account issuer (e.g., for each gift card issuing retailer), and transmits the account information to the account issuer. The account issuer then verifies the accounts, transmits the account balances to a trust account, and reports to the donation processor the verified card number and amounts remaining. The trust account then distributes money to the recipient non-profit organizations identified by the consumers.

According to one embodiment of the present invention, a system for processing donations of stored value accounts includes a user interface configured to receive a first account identifier, a first issuer identifier, and a first donee identifier; and a donation processor configured to process the first account identifier, the first issuer identifier, and the first donee identifier and to transmit the first account identifier and the first donee identifier to a first issuer associated with the first issuer identifier.

According to another embodiment of the present invention, a method for processing donations of stored value accounts includes receiving a first issuer identifier; receiving a first account identifier associated with a first stored value account and the first issuer identifier; receiving a first donee identifier; transmitting the first account identifier to a first issuer associated with the first issuer identifier; and crediting a first account corresponding to the first donee identifier with an amount corresponding to a balance of the first stored value account.

### BRIEF DESCRIPTION OF THE DRAWINGS

FIG. 1 is a diagram of a transaction process between a consumer and a retailer when purchasing goods or services using a gift card;

FIG. 2 is a diagram of a system for processing the donation of stored value accounts according to one embodiment of the present invention;

FIG. 3A is a screenshot of an account identifier entry screen of a user interface according to one embodiment of the present invention;

FIG. 3B is a flowchart illustrating operations between a user interface and a consumer according to one embodiment of the present invention;

FIG. 4A is a diagram of a transaction batching of a donation processor according to one embodiment of the present invention;

FIG. 4B is a flowchart illustrating operations by a donation processor according to one embodiment of the present invention;

FIG. 5A is a diagram of a transaction process between a donation processor, a card issuer, and a trust account according to one embodiment of the present invention;

FIG. 5B is a diagram of transaction process of a donation processor according to one embodiment of the present invention;

FIG. 5C is a flowchart illustrating operations by an issuer according to one embodiment of the present invention;

FIG. 6A is a diagram of a transaction process of a bank according to one embodiment of the present invention; and

FIG. 6B is a flowchart illustrating operations by a bank according to one embodiment of the present invention.

FIG. 7 is a schematic diagram of a card according to one embodiment of the present invention.

FIG. 8 is a flowchart illustrating a transaction process of processing a donation of a portion of a stored value card during purchase according to one embodiment of the present invention.

FIG. 9 is as screenshot showing a landing page for donating remnant value to a charity according to one embodiment of the present invention.

FIG. 10 is a screenshot showing a landing page for purchasing a gift card (or prepaid debit card) according to one embodiment of the present invention.

FIG. 11 is a screenshot showing a prepaid stored value card value selection process according to one embodiment of the present invention.

FIG. 12 is a screenshot showing a charity selection process according to one embodiment of the present invention.

### DETAILED DESCRIPTION

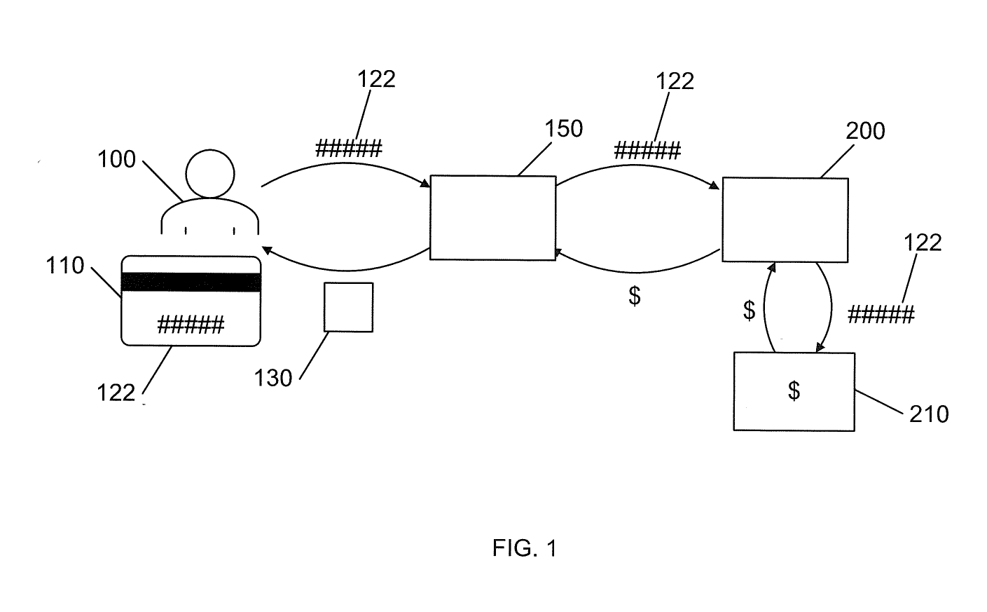

Referring to FIG. 1, a consumer (or donor) 100 holds a gift card (or stored value card) 110 from an issuer 200 (e.g., a stored value account issuer or a retailer). The gift card 110 has an account identifier 122 (e.g., an account number) which is associated with a stored value account 210 (or gift card account) which may initially have a balance corresponding to the amount of money paid for the gift card. When purchasing goods 130, the consumer 100 may provide the gift card 110 to the retailer 150. The retailer 150 provides the account identifier 122 to the issuer 200 (which may be the same entity as or a different from the retailer 150), and the retailer would deduct from a gift card account 210 corresponding to the account identifier 122 an amount of money corresponding to the value of the goods 130 purchased.

The gift card may be a “closed loop” or “open loop” gift card. A closed loop gift card is typically issued by a particular retailer and may only be used for goods and services offered by the issuing retailer. In contrast, open loop gift cards are typically issued by banks or credit card companies and can be redeemed at a variety of different retailers. When using an open loop gift card, an issuing bank or credit card company may act as an intermediary between the retailer and the gift card account.

The term “gift card” refers to the concept of a consumer's possessing an account identifier associated with a gift card account maintained by an issuer and does not require the existence of a physical gift card. For example, “gift card” could also include paper gift certificates having associated account identifiers, virtual gift cards that are delivered electronically and associated with particular user accounts (which may use a user name, account number, or other user identifier as an account identifier), travelers check cards, prepaid debit cards, or other arrangements in which a consumer possesses and can spend from a gift card account managed by an issuer. These gift cards can be purchased, sent, and maintained on electronic devices such as computers, mobile phones (e.g., smartphones), and other mobile devices.

The stored value associated with a particular gift card is treated as a liability on the issuer's balance sheet and the balance of the stored value is maintained in a gift card account associated with the gift card. When the gift card is used to make purchases, the associated gift card account is debited. A consumer cannot use the gift card to spend more than the amount stored in the associated gift card account. As a result, many of these gift card accounts hold only small remnant values that are too small to be useful to the gift card holders. However, depending on the jurisdiction, the issuer may be required to maintain the balances in the gift card accounts for eternity, forfeit a portion or all of the funds to the government as unclaimed property (i.e., escheat) after a set amount of time, or terminate or be exhausted by fees charged by the issuer.

Approximately $100 billion in gift cards was sold last year and between $5-8 billion of remnant values remain unused and forgotten in the gift card accounts of tens of millions of gift cards in America each year. Embodiments of the present invention provide systems and methods for recovering some of the unused stored value by making enabling gift card holders to donate their remnant balances to charities or non-profit organizations (or donees).

Embodiments of the present invention may benefit consumers by providing a secure, easy-to-use way to donate remaining gift and pre-paid debit card values to a charity of their choice from a group of participating charities or non-profits and a way to support charities without straining their budgets.

Embodiments of the present invention may also benefit charitable organizations by providing access to a new, never before tapped, renewable contribution stream; an opportunity to offer a new donation platform to their existing donor base; provide access to potentially thousands of new supporters; and to promote greater awareness of the organization's cause.

Embodiments of the present invention may also benefit the issuers by providing positive PR for allowing consumer card values to be donated; possible tax benefits from the donations to non-profit organizations; potential reduced overhead due to a reduced number of gift card accounts to maintain; and an opportunity to sell a new gift card or offer another promotion directly to a new or recurring customer.

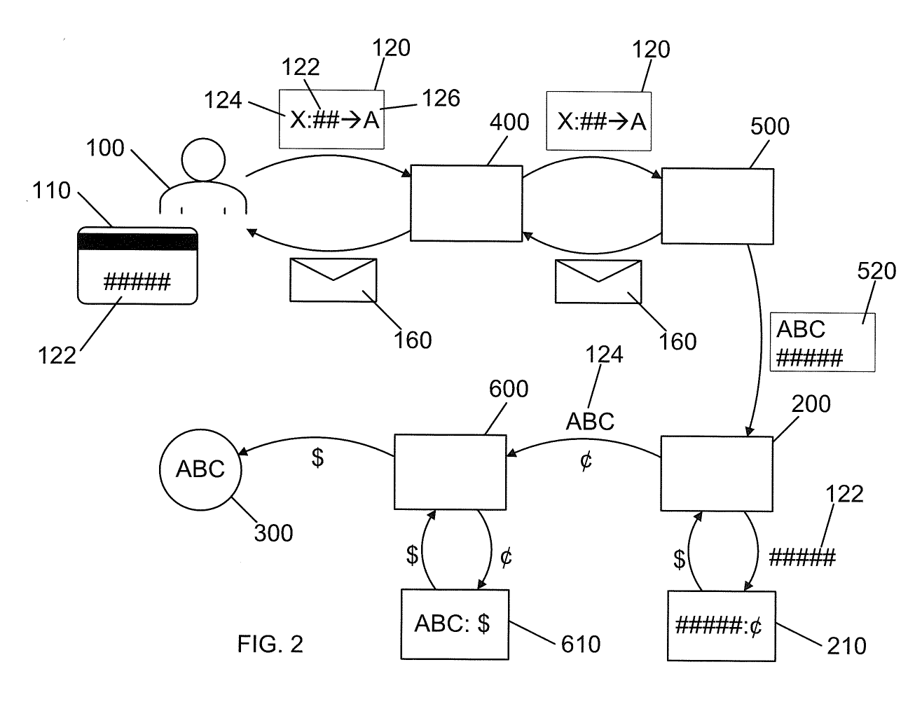

Referring to FIG. 2, according to one embodiment of the present invention, a consumer 100 holds a gift card 110 associated with an account identifier 122. The account identifier 122 is associated with a gift card account 210 managed by the issuer 200. When the consumer 100 wishes to donate the balance of his card to a charity or non-profit organization 300 (or donee), the consumer may transmit information 120 (including the account identifier 122 associated with the gift card, an issuer identifier 124, and a donee identifier 126) using a user interface 400 connected to the donation processor 500, which processes the transaction for the consumer 100. The donation processor 500 may also provide a message 160 to thank the consumer for the donation.

The donation processor 500 communicates with the issuer 200 over a secure channel and provides an account identifier 122 and the donee identifier 126 to the issuer 200. The issuer 200 deducts funds from the gift card account 210 associated with the account identifier 122 and transfers the funds directly to the identified donee 300 or transfers the funds along with the donee identifier 126 to a bank 600. The bank 600 adds the funds transferred from issuer 200 to a trust account 610 associated with the donee identifier 126. The bank 600 also transfers the funds from the trust account 610 to the donee 300 associated with the trust account 610, in accordance with instructions associated with that trust account 610. The bank 600 or the issuer 200 may also transfer a portion of the funds to the donation processor 500.

In more detail, the donation processor 500 receives information 120 from the consumer 100 via the user interface 400. This information 120 may include an account identifier 122 associated with the gift card 110, an issuer identifier 124 (e.g., identifying which retailer or bank issued the card), contact information of the consumer (e.g., email address, mailing address, and/or telephone number), and a donee identifier 126 identifying the particular donee 300 that the consumer would like to have the balance directed to. In one embodiment, the information identifying the issuer 200 may be included in the account identifier or may need to be separately identified by the user.

The user interface 400 may be a computer running a web browser displaying a website (e.g., a stand alone website or a web page integrated with the issuer's website); a stand-alone kiosk; a mobile device such as a phone, smartphone, PDA, or internet tablet; a point of sale device; or other networked device that is capable of accepting user input and interacting with a server (e.g., a server at or capable of communicating with the donation processor 500).

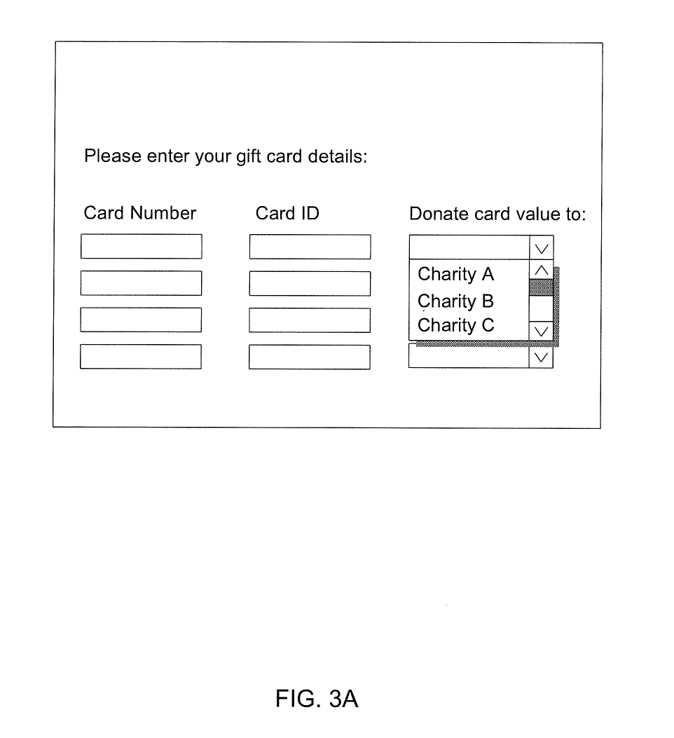

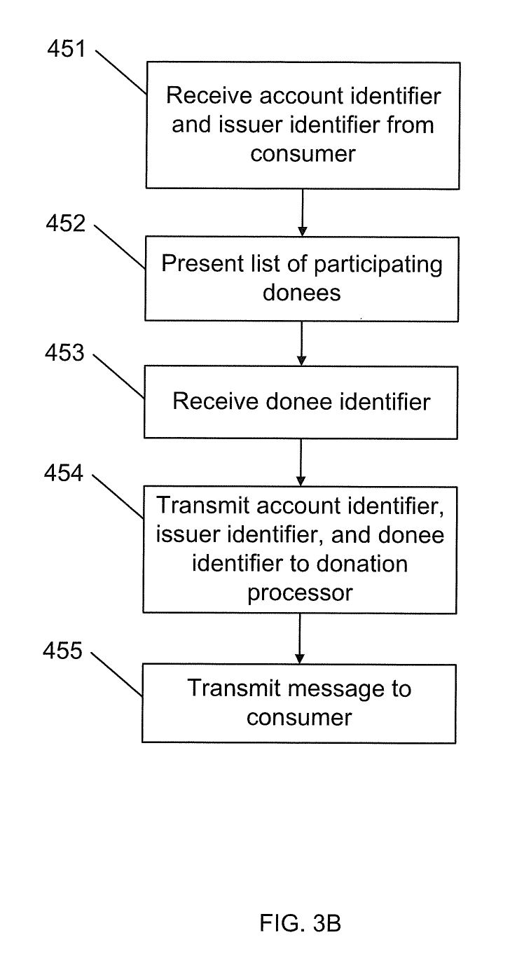

FIG. 3A is a screenshot of a website through which a consumer can enter account information according to one embodiment of the present invention. FIG. 3B is a flowchart illustrating operations by a donation processor with a consumer according to one embodiment of the present invention.

In one embodiment of the present invention, the user interface 400 provides a plurality of landing pages, the landing pages being associated with particular charities and issuers. A consumer accesses or arrives at the user interface 400 through a referral from a charity or an issuer. The user interface 400 determines the origination of the consumer based on which the landing page was used. In another embodiment, a referrer identifier (e.g., an HTTP referrer) may also be transmitted to the user interface 400 when the user interface 400 is accessed and the user interface may use the referrer identifier to determine the origination of the consumer.

A consumer can donate the funds stored in their gift card accounts through the user interface 400 by supplying the account identifier 122 and the issuer identifier 124 associated with the gift card 110 as well as a donee identifier 126. In one embodiment, the consumer may manually enter the account identifier and the issuer identifier by reading the values printed on the card and entering these numbers on the user interface 400 (451). In another embodiment, the user interface 400 includes a magnetic stripe reader (e.g., when the user interface is a point of sale device, a kiosk for providing the donation processing service, or a smartphone or computer having an integrated or peripheral device for reading magnetic strips) so that the user can enter the account identifier and issuer identifier by swiping the gift card 110 through the magnetic stripe reader. In another embodiment, the user interface 400 includes a barcode reader for scanning a barcode on the gift card 110 which includes a machine-readable representation of the account identifier and the issuer identifier. In still another embodiment, the user interface 400 includes a camera for taking a picture of a face of the gift card 110 in order to read a barcode or the account identifier and issuer identifier printed or embossed on the face of the gift card. In still another embodiment, the user interface 400 includes an RFID reader for reading an RFID tag storing an account identifier and issuer identifier on a gift card.

In one embodiment, the user interface 400 also allows the consumer to indicate which charity or non-profit organization 300 from a list of participating charities and non-profits they would like the funds stored in their gift card accounts to be donated to. The user interface 400 presents the list of participating donees (452) and the consumer indicates their choice (or choices) using user interface components well known in the art, such as by filling in forms or selecting icons using a keyboard and/or mouse on a display or using a finger or stylus on a touch sensitive display (453).

According to one embodiment of the invention, the consumer may also create a user account and log in to the donation processing service using user account management, login, and authentication processes that are well known in the art. A consumer's user account may include information provided by the consumer such as contact information, a history of past donations and amounts of those donations, and rewards points balance.

In one embodiment of the present invention, after submitting the account identifier, issuer identifier, and donee identifier to the donation processor 500 (454), the user interface 400 sends a message 160 to the consumer 100 via a contact method provided by the user (455). The message may be transmitted as an email, a message on a social networking service, a webpage, a text message to a cellular phone, a telephone call using an interactive voice system, or other means of electronic communication. The message may include text, audio, or video content and may be used to thank the consumer for the donation. The messages may be tailored or matched based on information known about the consumer, such as the identity of the issuer 200, the identity of the donee 300, and the user's past donations and reward balance.

In one embodiment, the message 160 also includes perks provided to the consumer 100 for their generosity. The perks may include coupons, rewards points, frequent flier miles, opportunities to purchase new gift cards at a discount, or other marketing techniques and tools as are well known in the art. The perks may be provided by the issuer 200 and/or the donee 300.

In one embodiment, the consumer 100 provides multiple account identifiers 122 associated with multiple gift cards. The account identifiers 122 may be associated with the same issuer or may be associated with different issuers. In one embodiment, the consumer may also identify multiple recipient (or donee) charities or non-profit organizations 300 to donate to along with information regarding how the donated gift card account funds should be allocated among the multiple recipient charities or non-profit organizations 300.

The donation processor 500 uses the information 120 received from the consumer to identify the issuer 200 associated with the account identifier 122 and a designated donee 300. In one embodiment, the donation processor 500 is connected to the issuer 200 via a secure connection (e.g., an HTTPS connection, a virtual private network (VPN), other TLS protocols, etc.) as is well known in the art for electronically processing financial transactions. The issuer 200 is also connected to a bank 600 which may manage a trust account 610 established for the benefit of the designated donee 300, which can the transfer the funds in the trust account 610 to the charity 300.

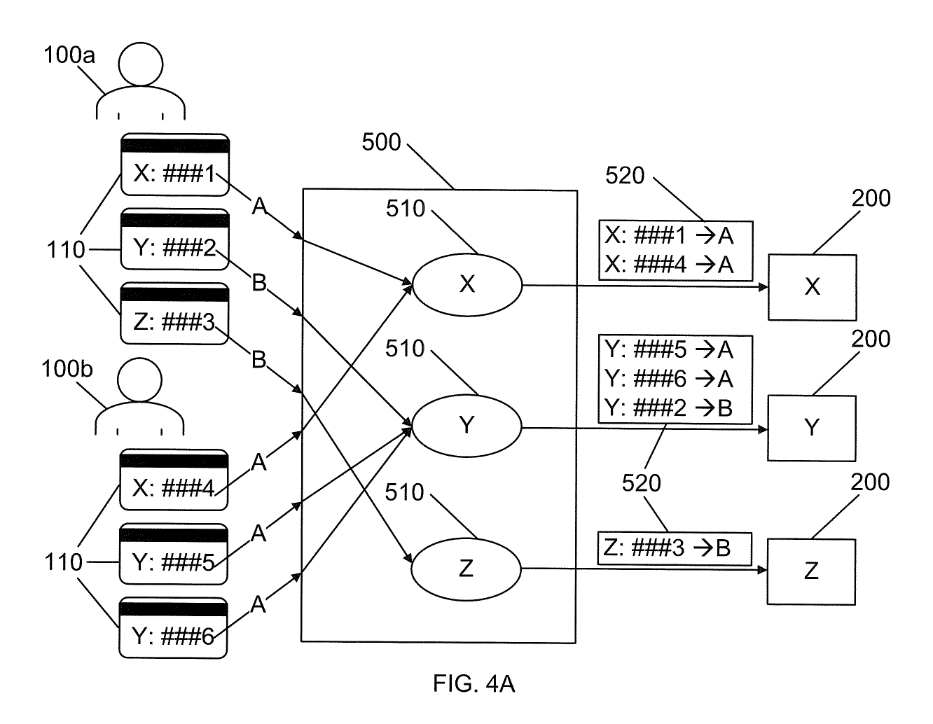

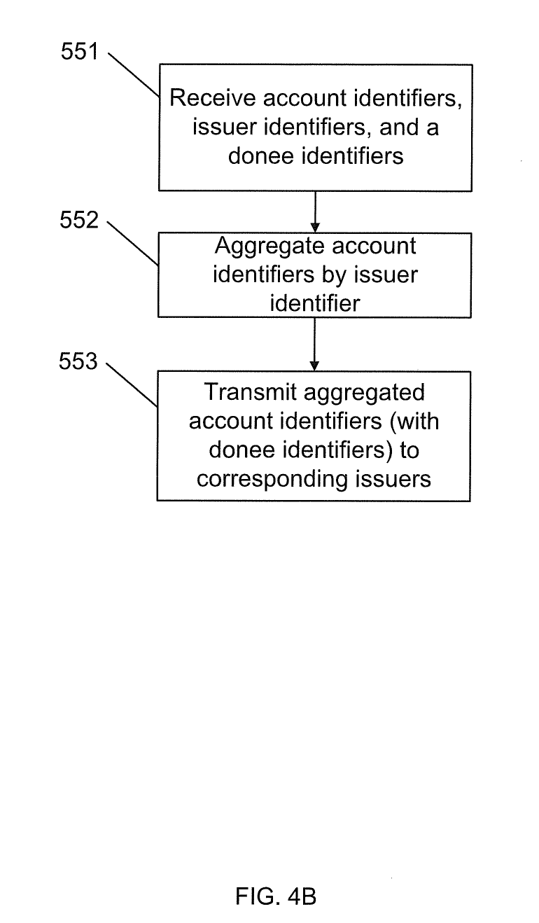

FIG. 4A is a diagram of a transaction batching of a donation processor 500 according to one embodiment of the present invention, in which consumers 100a and 100b hold gift cards 110 associated with issuers (200) X, Y, and Z and wish to donate the balances to charities A and B. FIG. 4B is a flowchart showing operations performed by the donation processor 500 of the embodiment shown in FIG. 4A.

The donation processor receives account identifiers, issuer identifiers, and donee identifiers from consumer 100a and 100b (551). The account identifiers are generally unique, while the received issuer identifiers and donee identifiers could be distinct or be the same. The donation processor 500 aggregates or batches the received account identifiers associated with the same issuer 200 (552). For example, in FIG. 4A an account identifier associated a gift card from issuer X held by consumer 100a is aggregated with another an account identifier associated with another gift card from issuer X held by consumer 100b. The donation processor 500 transmits aggregated transactions 520 to the individual issuers 200 corresponding to the issuers associated with the aggregated transactions, which also include indicators as to which charities the balances should be donated to (e.g., the labels “→A” and “→B” indicate that the balances of the gift card accounts should be donated to charities A and B, respectively) (553).

In one embodiment of the present invention, the donation processor 500 validates the account identifiers received from the consumer 100 with the issuer 200 when the account identifiers are first received. The validation process may include performing a checksum on the account identifier and issuer identifier, verifying the existence of a gift card account associated with the received account identifier and issuer identifier, and verifying a non-zero balance in the gift card account.

In embodiments of the present invention, the donation processor 500 can be implemented in a system that is capable of processing any number of gift cards provided by any number of issuers and held by any number of consumers to be donated to any number of charities such as a computer system or group of computers (such as in a computer cluster or a cloud computing system), which would be limited only by the memory and processing power available.

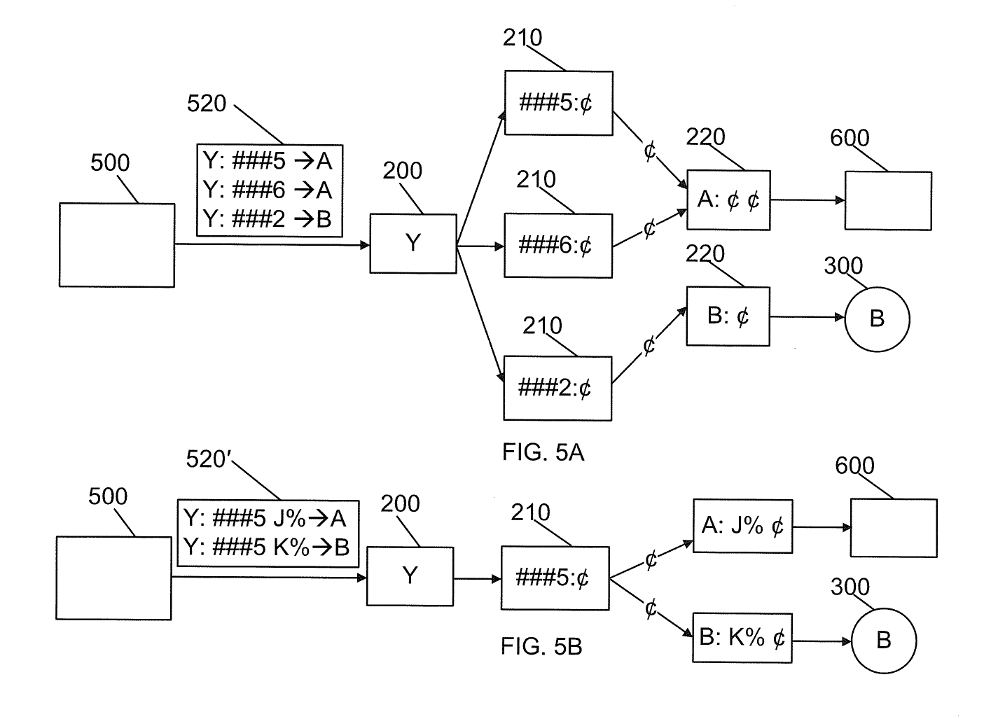

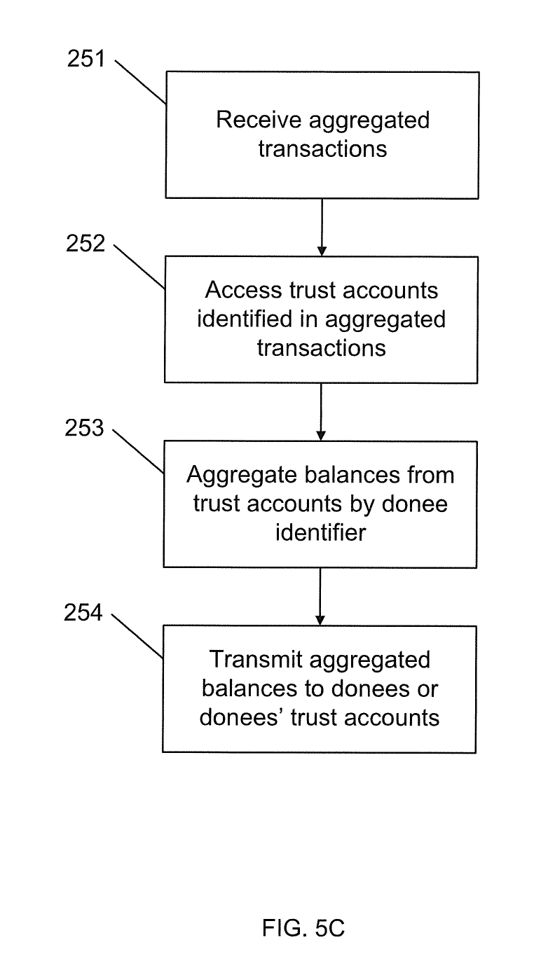

FIG. 5A is a diagram of an issuer 200 processing the aggregated transactions 520 according to one embodiment of the present invention. FIG. 5C is a flowchart showing operations performed by the issuer 200 according to the embodiment shown in FIG. 5A. The issuer 200 receives aggregated transactions 520 from the donation processor 500 (251). The issuer 200 withdraws funds from the gift card accounts 210 identified in the aggregated transactions (252) and aggregates the funds from those gift card accounts 210 based on the associated identified charities or non-profit organizations 300 (253). The balances 220, aggregated by recipient, are then transmitted either directly to the donees 300 or to banks 600 managing trust accounts 610 for the benefit of the donees 300 (254). A single bank 600 may handle trust accounts 610 for multiple charities or non-profit organizations 300 and different charities or non-profit organizations 300 may have their trust accounts 610 managed by different banks 600.

FIG. 5B is a diagram of an issuer 200 processing the aggregated transactions 520′ according to another embodiment of the present invention, wherein the consumer 100 also provides information specifying monetary amounts or a percentages associated with an account identifier and multiple charities or non-profit organizations such that a portion of the remaining balance is directed to a first identified donee and another portion of the remaining balance may be directed to a second identified donee. During the process of selecting recipient charities, summary descriptions of the activities of those charities may be displayed and the consumer 100 may add charities to a “shopping cart”. In addition, a search feature allows a user to select charities based on criteria such as particular disaster relief efforts. For example, a consumer 100 who chooses to support victims of a recent Japanese tsunami may search using the keywords “Japanese tsunami” and charitable organizations related to relief efforts would be shown to the user for selection. When the consumer 100 has finished selecting charities, the consumer may choose the manner in which funds are allocated between the selected charities.

In some embodiments of the present invention, the consumer 100 with an account may also be able to view recent news stories associated with the organizations that the consumer donated to. For example, if the consumer 100 previously donated to the American Red Cross®, reports of recent activities of the American Red Cross® (e.g., sending teams to provide disaster relief to victims of a tornado) would appear in a news page customized for the consumer 100.

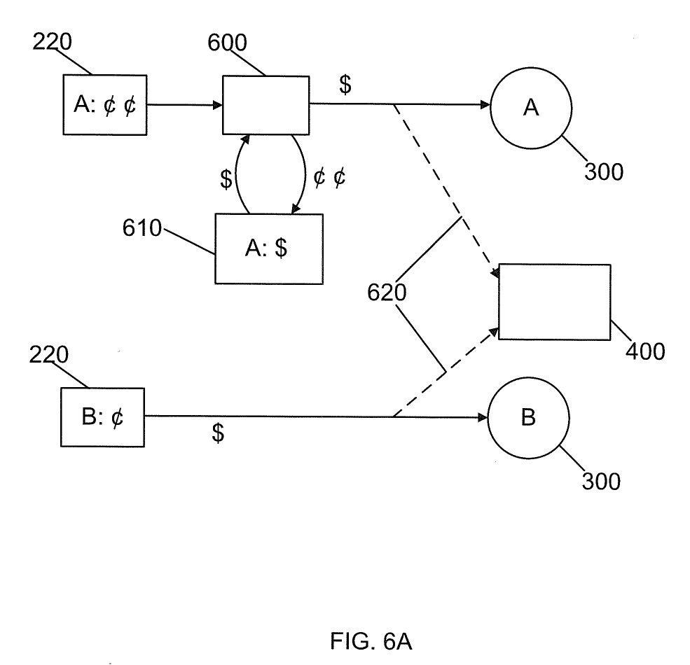

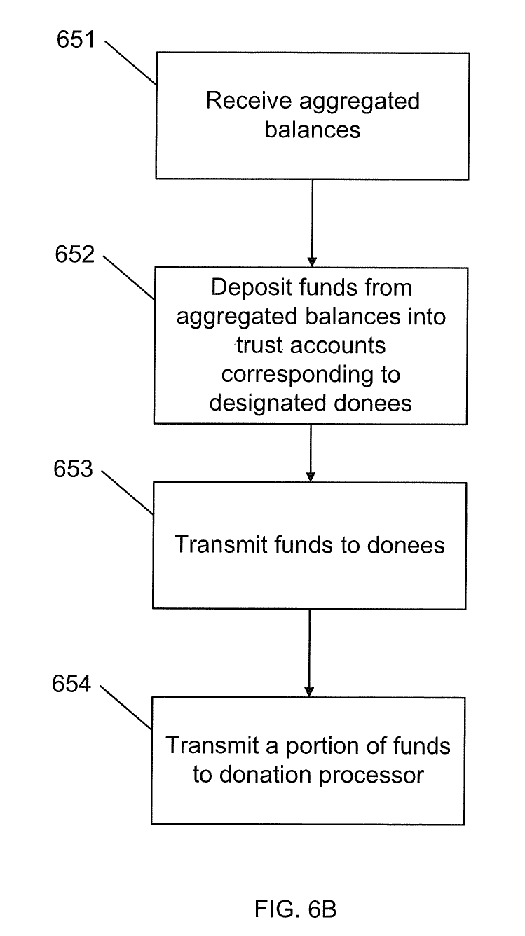

FIG. 6A is a diagram of a bank (or multiple banks) 600 processing aggregated balances 220 and distributing funds to charities or non-profit organizations 300. FIG. 6B is a flowchart showing operations performed by a bank 600 according to embodiment shown in FIG. 6A. The bank 600 receives aggregated balances 220 (651) and deposits the received aggregated balances 220 into trust accounts 610 associated with the identified recipient charities or non-profit organizations 300 (652), where the received balances may be further aggregated with the balances already in those trust accounts 610 to be sent to the charities or non-profit organizations 300 at a later time or sent immediately (653). In one embodiment, a portion of the balance of the trust account 610 is sent 620 to the donation processor 500 as compensation for the service provided (654).

In some embodiments of the invention, a logging and auditing system is also provided to generate and provide a history of the transactions between the consumers 100, the issuers 200, the donation processor 500, the banks 600, and the donees 300. This logging and auditing system can be provided using any of the well known financial transaction monitoring and auditing systems as are well known in the art and used, for example, for compliance with government regulations regarding taxation, charitable giving, and non-profit entities. The logging and auditing system may be used, for example, to ensure that the total funds distributed to the donees 300 and the donation processor 500 match the total amount donated by the consumers 100 and the issuers 200.

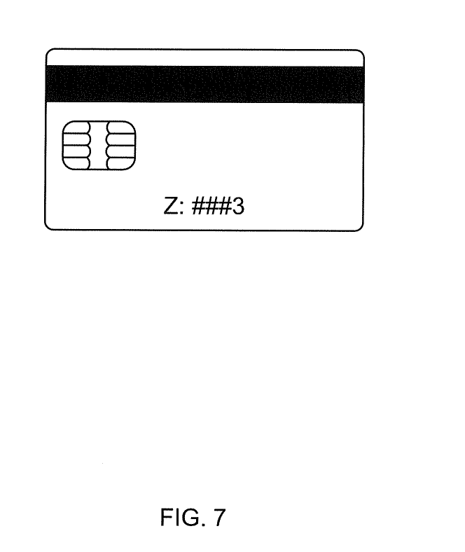

FIG. 7 is a schematic diagram of a stored value card according to one embodiment of the present invention. Although the stored value card is depicted as a magnetic stripe card, in other embodiment, the stored value card may be a smart card, a contactless smart card, a radio-frequency identification (RFID) device (e.g., a card or a key fob), a smartphone with a Near Field Communications (NFC) chip, or other suitable payment device, artifact, or identifier.

In some embodiments of the present invention, the stored value card is a prepaid debit card in which a portion of the value of the stored value card is donated to a charity of choice at the time of purchase. The purchase may be made at, for example, a brick and mortar store, on a website, or through a mobile application. The designation of the particular charity may be automatically determined by the type of card purchased or may be selected at a later time by the consumer 100 or a recipient of the stored value card. For example, a consumer may pay $100 for a stored value card which includes an automatic donation of a percentage (e.g., 10% or $10) to the American Red Cross®. Such a stored value card may be branded with the name and logo of the associated charity. In these embodiments, the stored value card would have the remaining percentage (e.g., 90% or $90) of value which can be used to purchase goods and services. In another embodiment, a consumer 100 may pay $100 for a stored value card which includes the same automatic donation (e.g., 10%), but in which the recipient charity is left unspecified. In such an embodiment, the stored value on the card would be less than the amount paid for the card (e.g., a stored value of $90) and the consumer 100 or a recipient of the stored value card may later register the card via, for example a website or an application running on a mobile device. During the registration process, charities may be shown and selected from a catalog in a manner similar to the donation of remnant values described above. Multiple recipient charities can also be selected, as described above.

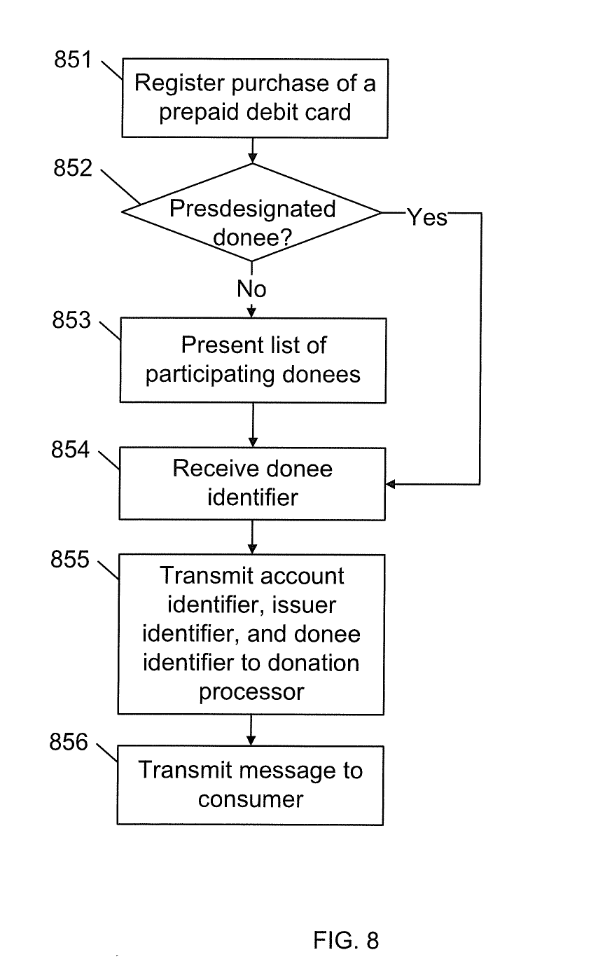

FIG. 8 is a flowchart illustrating a method of processing a donation associated with a prepaid debit card. Initially, the system may register the purchase of a prepaid debit card by a consumer (851). If the donee has been not been predesignated, then a list of participating donees is presented (853) to the consumer, who selects from among a list of participating donees. The predesignated or selected donee is then received (854) by the system, and the account identifier, issuer identifier, and donee identifier are transmitted to a donation processor (855). A message is then optionally transmitted (856) to the consumer.

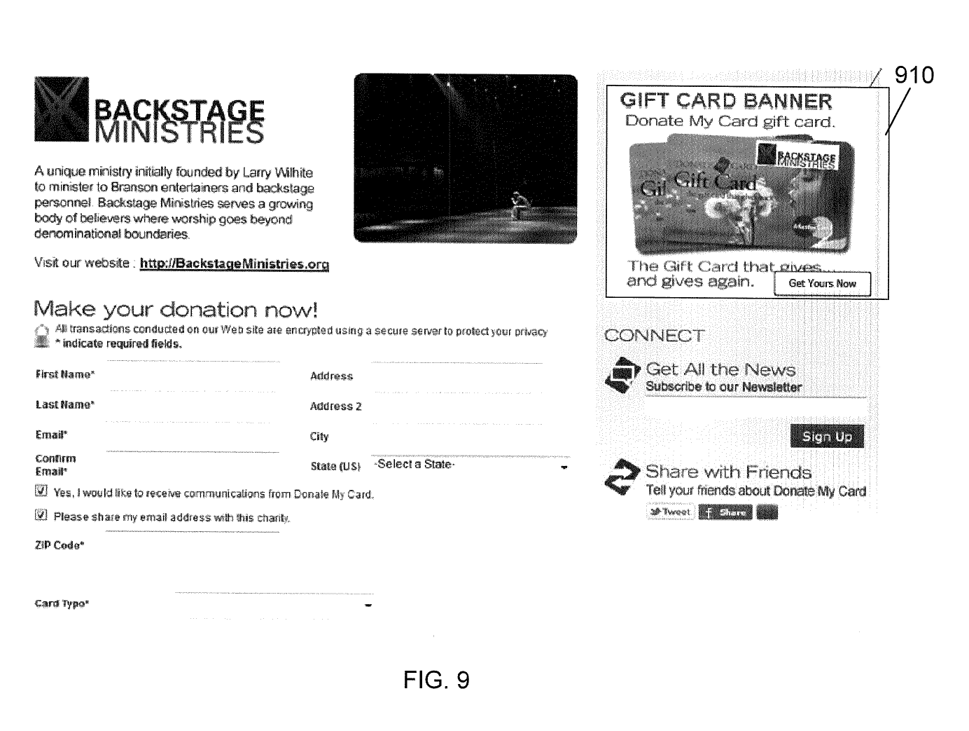

FIG. 9 is as screenshot showing a landing page for donating remnant value to a charity according to one embodiment of the present invention. In some embodiments, the landing page includes a banner advertisement 910 to inform the consumer of the opportunity to purchase gift cards (or prepaid debit cards) with accompanying donations according to embodiments of the present invention.

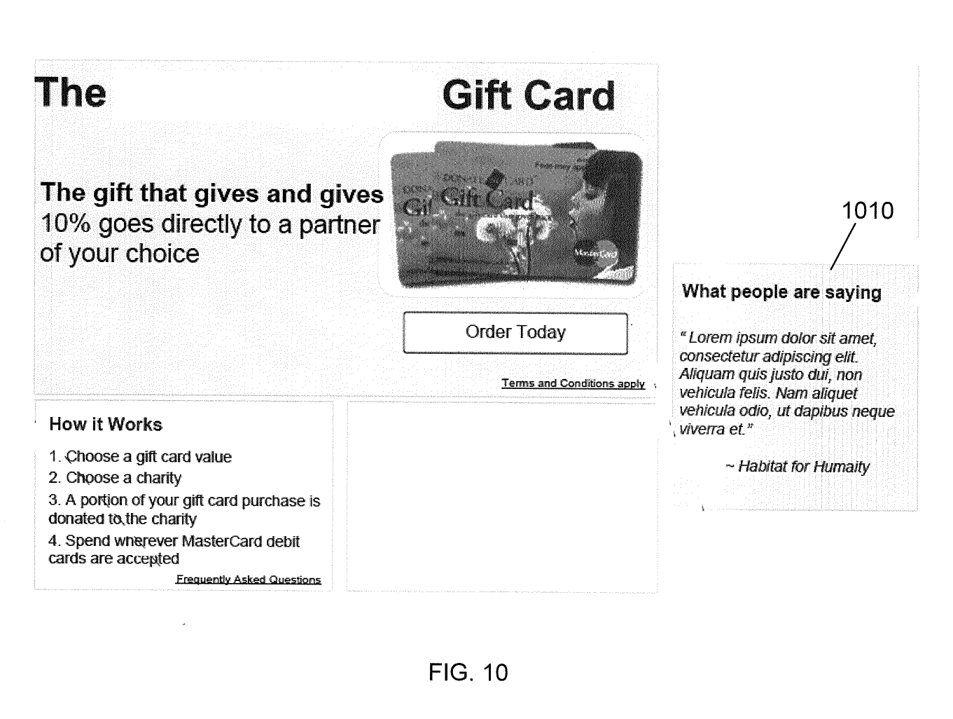

FIG. 10 is a screenshot showing a landing page for purchasing a gift card (or prepaid debit card) according to one embodiment of the present invention. According to one embodiment, the landing page further includes a promotion box 1010 which includes information promoting a charity, such as a quote from a volunteer or a beneficiary of the services provided by the charity. A number of quotes may be sequentially shown or scroll through the promotion box 1010. The promotion box may also appear in other portions of the user interface. The landing page shown in the embodiment of FIG. 10 is designed to be simple and straightforward with, for example, a single “order now” button.

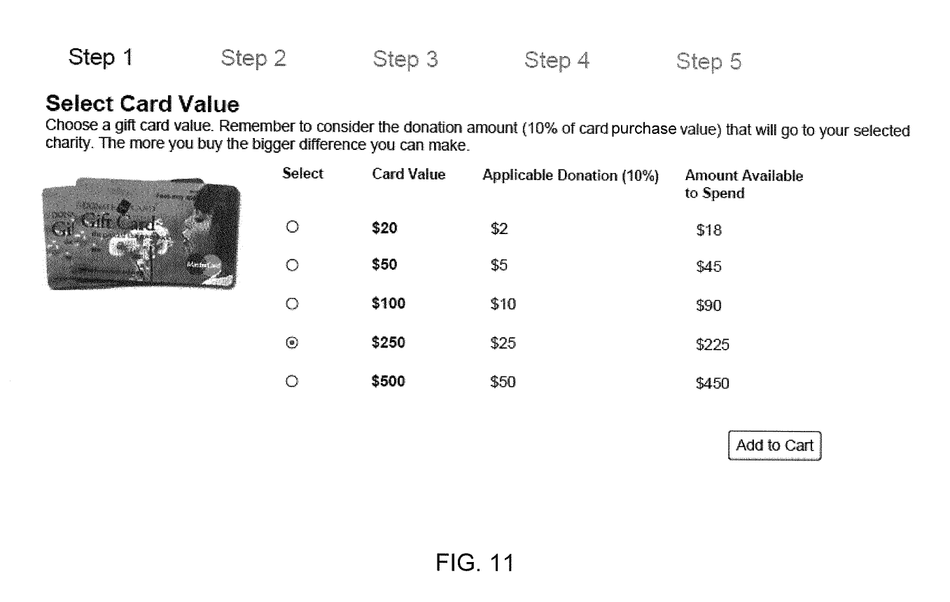

FIG. 11 is a screenshot showing a prepaid stored value card value selection process according to one embodiment of the present invention. In the embodiment shown in FIG. 11, a flat 10% of the value paid for the card is donated to charity and only discrete values (e.g., $20, $50, $100, $250, and $500) may be paid for the card (to receive corresponding values of $18, 45, $90, $225, and $450). In other embodiments of the present invention, the percentage donated may be varied by the consumer. In addition, in other embodiments, the value of the card may be selected with more granularity (e.g., more values between the specified values or a user specified value can be entered).

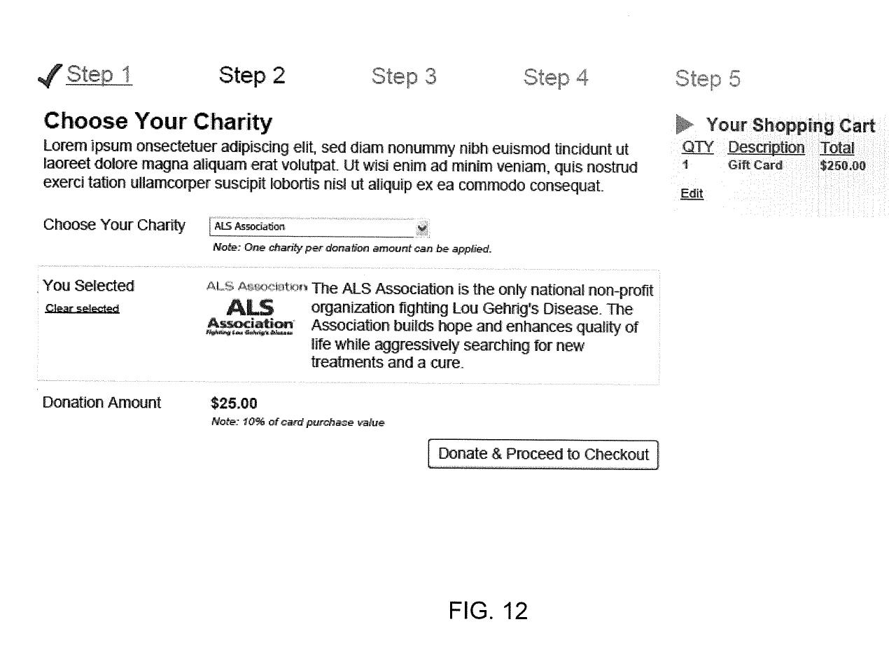

FIG. 12 is a screenshot showing a charity selection process according to one embodiment of the present invention. In the embodiment shown in FIG. 12, a charity can be selected from a drop down box and a brief description of the selected charity appears below the drop down box. In other embodiments, multiple charities can be selected through multiple drop down boxes and the donation can be allocated among the multiple charities.

While the invention has been described in connection with certain exemplary embodiments, it is to be understood to those skilled in the art that the invention is not limited to the disclosed embodiments, but, on the contrary, is intended to cover various modifications included within the spirit and scope of the appended claims and equivalents thereof.

What is claimed is:

1. A system for processing donations of stored value accounts, the system comprising:
a user interface configured to receive a first account identifier, a first issuer identifier, and a first donee identifier; and
a donation processor configured to process the first account identifier, the first issuer identifier, and the first donee identifier and to transmit the first account identifier and the first donee identifier to a first issuer associated with the first issuer identifier.

2. The system of claim 1, wherein the user interface is further configured to receive a second account identifier, a second issuer identifier, and a second donee identifier, and
wherein the second issuer identifier is also associated with the first issuer and the donation processor is further configured to aggregate the first account identifier with the second account identifier and to transmit the aggregated first and second account identifiers.

3. The system of claim 1, wherein the user interface comprises a website on a web server.

4. The system of claim 1, wherein the user interface comprises a mobile device.

5. The system of claim 1, wherein the user interface comprises a computer.

6. The system of claim 1, wherein the user interface comprises a point of sale device.

7. The system of claim 1, wherein the donation processor is further configured to deliver a message comprising a perk in response to receiving the first account identifier, the first issuer identifier, and the first donee identifier.

8. The system of claim 7, wherein the message further comprises an audio message.

9. The system of claim 7, wherein the message further comprises an interactive voice response.

10. A method for processing donations of balances of stored value accounts, the method comprising:
receiving a first issuer identifier;
receiving a first account identifier associated with a first stored value account and the first issuer identifier;
receiving a first donee identifier;
transmitting the first account identifier to a first issuer associated with the first issuer identifier; and
crediting a first account corresponding to the first donee identifier with an amount corresponding to a balance of the first stored value account.

11. The method of claim 10, further comprising:
receiving a second account identifier associated with a second stored value account and the first issuer identifier,
wherein the transmitting the first account identifier to the first issuer includes transmitting the second account identifier along with the first account identifier to the first issuer.

12. The method of claim 11, further comprising:
receiving a second donee identifier, the second donee identifier being the same as the first donee identifier,
wherein the crediting the first account corresponding the first donee identifier further comprises crediting the first account with a balance corresponding to the second stored value account.

13. The method of claim 11, further comprising:
receiving a second donee identifier, the second donee identifier being different from the first donee identifier; and
crediting a second account corresponding to the second donee identifier with an amount corresponding to a balance of the second stored value account.

14. The method of claim 10, further comprising:
validating the first account identifier with the first issuer.

15. The method of claim 10, further comprising:
transmitting a message to a consumer associated with the first account identifier, wherein the message comprises a perk.

16. The method of claim 15, wherein the perk is a coupon, an offer of a discounted gift card, rewards points, or frequent flier miles.

17. The method of claim 15, wherein the message is an interactive voice response.

18. The method of claim 15, wherein the message comprises an audio message.

19. The method of claim 15, wherein the message comprises a video message.

20. The method of claim 10, wherein the receiving the first issuer identifier, the receiving the first account identifier, and receiving the first donee identifier occurs at a time of purchase of the first stored value account.

21. The method of claim 10, wherein the receiving the first issuer identifier, the receiving the first account identifier, and receiving the first donee identifier occurs during a registration process for the first stored value account.
